(19) United States
(12) Patent Application Publication
(10) Pub. No.: US 2023/0385922 A1
(43) Pub. Date: Nov. 30, 2023

(54) SYSTEM AND METHOD FOR BID SOLICITATION WITH SEALED BIDS

(71) Applicants: Timothy HOOVER, San Diego, CA (US); Leo MATA, San Jose, CA (US); Jochem HOEFNAGELS, San Diego, CA (US)

(72) Inventors: Timothy HOOVER, San Diego, CA (US); Leo MATA, San Jose, CA (US); Jochem HOEFNAGELS, San Diego, CA (US)

(21) Appl. No.: 18/111,398

(22) Filed: Feb. 17, 2023

Related U.S. Application Data
(63) Continuation of application No. 63/311,573, filed on Feb. 18, 2022.

(51) Int. Cl. G06Q 30/08

(52) U.S. Cl. CPC G06Q 30/08

(57) ABSTRACT

A system facilitates requests for proposals, or the solicitation of bids for contract work, by a property owner or their representative for work to be done. The system provides a public-facing user directory to aid in requesting bids from vendors. A question-and-answers feature about the scope during the bidding period minimizes the need for change orders after the project starts and avoids misunderstandings and loss of trust between vendors and customers. Bids are sealed until all bids are received, avoiding opportunities for price manipulation by sharing of bidding or financial data with other prospective bidders.

### RELATED APPLICATION

This application claims the benefit of priority to U.S. Provisional Patent Application No. 63/311,573 for “System and Method for Bid Solicitation with Sealed Bids,” filed Feb. 18, 2022, and currently co-pending which is incorporated herein by reference.

### FIELD OF THE INVENTION

The present invention pertains generally to electronic systems for sealed bidding. The present invention is particularly, but not exclusively, useful for requesting and submitting bids for contract work.

### BACKGROUND OF THE INVENTION

When a work project needs to be completed, many industries rely on the process of issuing request for proposals, receiving proposals from interested service providers, and then selecting the best proposal for the project. As one example, property owners or their representatives often seek bids from service providers such as contractors for work projects to be performed on the property. It is common for property representatives to be required to obtain at least three bids on projects greater than a specific size or cost.

In order to obtain the necessary bids, a property representative usually has a list of preferred vendors or service providers that the property representative invites to bid. These preferred vendor lists are controversial because they are usually “pay-to-play” models in which vendors pay for inclusion on the list with the expectation that they will make the money back through the ability to obtain work projects because of the limited competition.

Moreover, when a property owner or representative requests bids for a project, the property representative who is collecting the bids often has a favorite, and will tell the favorite to wait to submit its bid until the other bidders have submitted their bids. Prior to the favorite's bid submission, the property representative will share the details and/or prices from the prior bids with the favorite, allowing the favorite to submit a lower bid—often with the expectation of upsells and change orders as discussed below.

Oftentimes when bidding is sought on a project, a scope of work is not issued, or is issued but poorly defined. Some contractors notice missing or unclear language and treat it as an opportunity to provide a low bid that is in compliance with the missing or unclear language, with the intention of change orders and upsells. Once the contractor starts the project, the change orders also begin. Other than a poorly defined scope of work, change orders can arise from unforeseen circumstances. Nonetheless, in the end, the project cost often greatly exceeds the bid price, the property owner is frustrated, trust is lost, and nobody wins.

In view of the above, it would be advantageous to provide a bidding platform that provides a fair opportunity to all bidders and reduces the ability for price manipulation, price fixing, and collusion. It would be further advantageous to provide a bidding platform that facilitates a clear understanding and expectation of a scope of work. It would be further advantageous to provide a bidding platform that facilitates inviting of qualified service providers or property management companies to bid or participate in the bid process.

### SUMMARY OF THE INVENTION

Disclosed is a system and method for collecting bids with scope question and answer features and sealed bids. A process performed by preferred embodiments to request and obtain bids includes a scope question-and-answer period, digital sealing of bids, and a public-facing user directory.

A preferred embodiment of the system includes a processor and a data storage medium containing instructions performed, after translation (e.g. from an interpreted programming language, bytecode, just-in-time compilation, or a combination thereof) in some preferred embodiments, by the processor to solicit and accept bids for contract work.

The system of the present invention is applicable to a number of industries in which a “work purchaser” such as a property owner, either directly or through the use of a third party “bid facilitator” such as a property management company or representatives engaged by the work purchaser, seek competitive bids for work projects.

As used herein, the term “work purchaser” is intended to identify the ultimate purchaser of the work pursuant to an accepted bid. In the case where a property owner maintains control of the key economic decisions of a property, the property owner would be the work purchaser. However, in the case where a property owner has delegated the duty to maintain the property to a property management company, the property management company would be considered the work purchaser.

As used herein, the term “bid facilitator” is intended to identify the person or entity that creates the request for bids. In the case where a property owner directly manages the property, the property owner would act as the bid facilitator. In the case where a property owner has a property management company, the property management company would act as the bid facilitator.

Users of the system, including work purchasers, bid facilitators, bidders, and non-bidding participants, interact with the system indirectly through their own computing devices running a web browser or other application to communicate with the system.

In an exemplary use, a bid facilitator adds a bid summary, optionally with an attachment containing the scope of work, and information about the project. The bid facilitator is provided by the system with a public-facing user directory allowing the bid facilitator to invite bidders directly from the directory. In some preferred embodiments, bid facilitators may alternatively invite bidders from a preexisting database of vendors regularly used by the bid facilitator, invite specific vendors whose information is directly provided by the bid facilitator, or invite from a combination of bidders from the directory, a preexisting database of regularly used vendors, and specific vendors.

The bid facilitator also adds a bid deadline that, in preferred embodiments, cannot occur prior to seven (7) days from when bid requests are sent out.

Bid requests are then sent to the selected vendors, who can submit questions to be answered by the bid facilitator and perhaps the work purchaser (scope Q/A) until forty-eight (48) hours prior to the bidding deadline. The system allows all participants to see questions and answers. In preferred embodiments, the questions are asked anonymously, so that the name of the bidder asking the question is not displayed.

When a bidder is ready to submit a bid, the system provides the bidder with an option to attach and incorporate the scope Q/A as an addendum to the bidder's contract. This allows decision makers (work purchaser or bid facilitator) to give priority to bidders who attach the scope Q/A on the basis that the bidder considered and incorporated the scope Q/A into the bidder's contract and thus the change orders based on the scope discussion are less likely.

When a bid is submitted, it is sealed—made unavailable to participants, including the work purchaser, bid facilitator or other decision makers—until all bids are received. By digitally sealing bids until all bids are submitted or a deadline expires, the work purchaser is unable to access and share the bids or financial information of any of the participants. This reduces the opportunity for price manipulation.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a diagram of exemplary hardware components of a preferred embodiment of a system for bid solicitation and contract bidding;

FIG. 2 is a diagram of a composite system in which sealed bidding is conducted with participants using remote devices;

FIG. 3 is a flowchart illustrating the general steps performed to conduct the collection and sealing of bids by a preferred embodiment of a system for bid solicitation and contract bidding;

FIG. 4 is a flowchart illustrating the initial steps taken by a user to access a preferred embodiment of a system for bid solicitation and contract bidding;

FIG. 5 illustrates an exemplary user interface for performing the steps illustrated in FIG. 4;

FIG. 6 is a flowchart illustrating the login process taken by a user to log into a preferred embodiment of a system for bid solicitation and contract bidding;

FIG. 7 is a flowchart illustrating the sign-up process for a preferred embodiment of a system for bid solicitation and contract bidding;

FIG. 8 is a flowchart illustrating exemplary data collected for different types of roles during the sign-up process;

FIG. 9 illustrates an exemplary dashboard user interface;

FIG. 10 is a flowchart illustrating the creation of a bid request by a bid facilitator, property owner or property manager, in a preferred embodiment of a system for bid solicitation and contract bidding;

FIG. 11 is a flowchart illustrating exemplary data collected to build the bid scope during the creation of a bid request;

FIG. 12 illustrates an exemplary user interface for creating a bid request;

FIG. 13 is a flowchart illustrating the invitation of bidders in a preferred embodiment of a system for bid solicitation and contract bidding;

FIG. 14 illustrates an exemplary user interface for inviting bidders;

FIG. 15 illustrates an exemplary user interface for searching and inviting bidders in a preferred embodiment of a public-facing directory;

FIG. 16 is a flowchart illustrating the invitation of non-bidding participants in a preferred embodiment of a system for bid solicitation and contract bidding;

FIG. 17 is a flowchart illustrating the invitation of a bidder and the option to accept or decline the bid invitation in a preferred embodiment of a system for bid solicitation and contract bidding;

FIG. 18 is a flowchart illustrating the assembly of a bid in a preferred embodiment of a system for bid solicitation and contract bidding;

FIG. 19 is a flowchart illustrating the use of a question-and-answer (Q/A) forum in a preferred embodiment of a system for bid solicitation and contract bidding;

FIG. 20 illustrates an exemplary user interface for assembling a bid;

FIG. 21 illustrates an exemplary user interface for a Q/A forum;

FIG. 22 is a flowchart illustrating the submission of a final bid in a preferred embodiment of a system for bid solicitation and contract bidding;

FIG. 23 is a flowchart illustrating the sealing of a submitted bid in a preferred embodiment of a system for bid solicitation and contract bidding;

FIG. 24 illustrates an exemplary user interface for submitting a final bid; and

FIG. 25 is a flowchart illustrating the unsealing of bids and the decision of a winning bid in a preferred embodiment of a system for bid solicitation and contract bidding.

### DETAILED DESCRIPTION

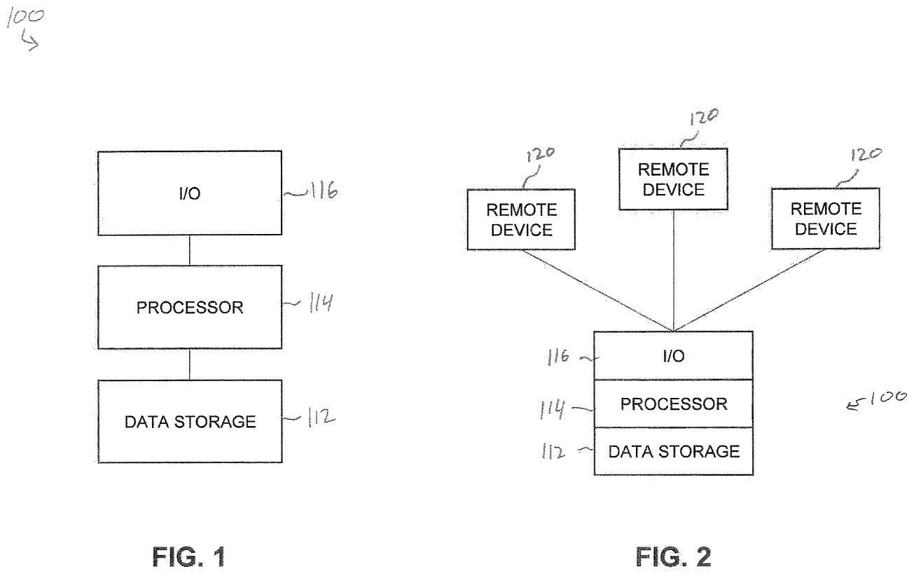

Referring initially to FIG. 1, a preferred embodiment of a system for bid solicitation and contract bidding is illustrated and generally designated 100. System 100 includes a data storage medium 112, processor 114, and input-output (I/O) hardware 116. In a preferred embodiment, I/O hardware 116 includes a network card or other networking device that provides access to the Internet, through which processor 114 sends output to remote users and receives input from them, as further illustrated in FIG. 2. Storage medium 112 includes instructions that cause processor 114 to perform the processes described herein as well as data necessary or useful to the processes, such as bid data and user directory data. Instructions and data do not need to be on the same particular medium, and each can also be spread across and duplicated across various particular media; embodiments in which storage medium 112 constitute a plurality of hardware apparatuses are fully contemplated. Similarly, processor 114 is not limited to a single processor. Exemplary embodiments of system 100 include one or more servers (locally hosted or in a data center), virtual servers hosted by a cloud provider, and software running on “serverless” hosting provided by a cloud provider. A person of ordinary skill in the art will recognize that each of these embodiments includes at least a data storage medium 112, a processor 114, and I/O hardware 116, although they provide different levels of abstraction over the hardware on which system 100 operates.

Referring now to FIG. 2, preferred embodiments of system 100 are accessed by end users via remote devices 120. Although embodiments in which both creation of bid requests and participation in bidding are performed entirely with a single-computer embodiment of system 100 are contemplated, for convenience and usability, preferred embodiments of system 100 are accessed by work purchasers, bid facilitators, requesters, bidders, and other participants through their own computing devices, represented by remote devices 120.

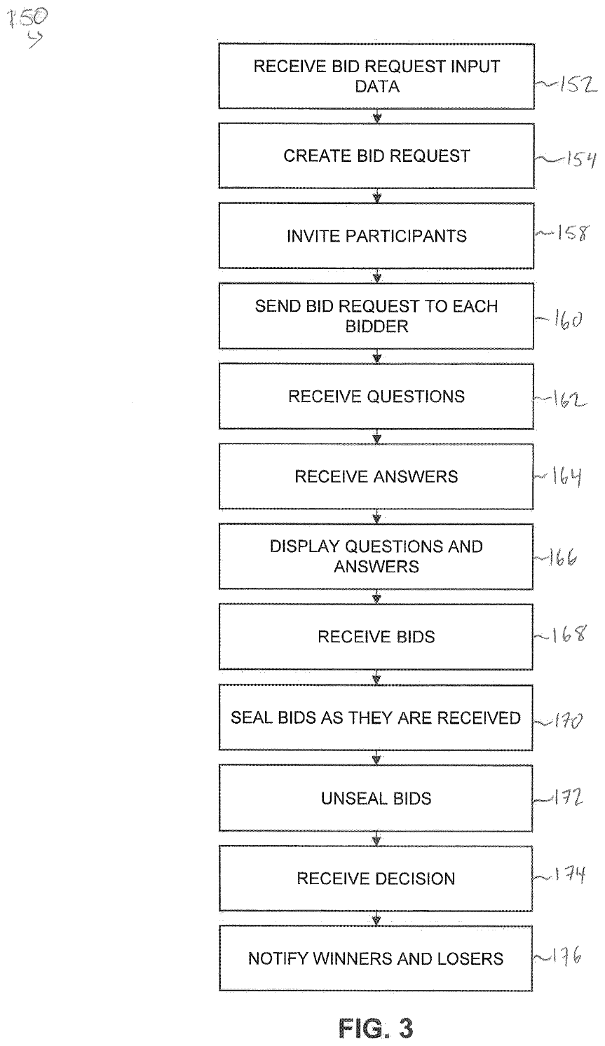

Referring now to FIG. 3, a method performed by system 100 to solicit and seal bids is illustrated and generally designated 150. In order to solicit bids for a work contract, system 100 receives bid request input data from a work purchaser or bid facilitator in step 152. When the system of the present invention is utilized in the construction or construction maintenance industry, exemplary work purchasers may include property owners working directly or in conjunction with bid facilitators, such as property managers, seeking bids for a work project for the property. Based on the data provided, the system creates a bid request in step 154 and invites participants in step 158. In a preferred embodiment, the participants to be invited are selected by the bid facilitator, and include bidders and, depending on the needs of the work purchaser, may also include decision makers and other non-bidding spectators.

In step 160, system 100 sends a bid request to each bidding participant. However, in preferred embodiments, bids are not finalized until after a question-and-answer (Q/A) period. More particularly, at the time step 160 is performed, a Q/A period is opened, during which system 100 receives questions from participants, as illustrated by step 162, and receives answers from the work purchaser or bid facilitator, as illustrated by step 164. As illustrated by step 166, both the questions and answers are displayed to bidding and non-bidding participants.

In preferred embodiments, the bidding deadline is required to be at least seven days from step 160 so that the Q/A period can end forty-eight (48) hours before the deadline for submitting bids. After the end of the Q/A period, bids can be submitted or finalized by bidding participants, as illustrated by system 100 receiving finalized bids in step 168. As illustrated by step 170, all bids are sealed as they are received, meaning that they are not displayed by system 100: no participant, including the work purchaser, bid facilitator, or other participants, can access them until all bids are received and the bids are unsealed together in step 172.

Once the bids are unsealed together in step 172, a decision maker or decision makers—usually the bid facilitator or work purchaser, one or more non-bidding participants deciding for the work purchaser, or both—review the bids and determine which bid to accept. The decision makers provide their decision to system 100, which receives it as input in step 174. System 100 then performs step 176 of notifying the winning bidder that they won the bid, and the losing bidders that they did not win. In a preferred embodiment, the notifications of step 176 are sent to the bidding participants via email.

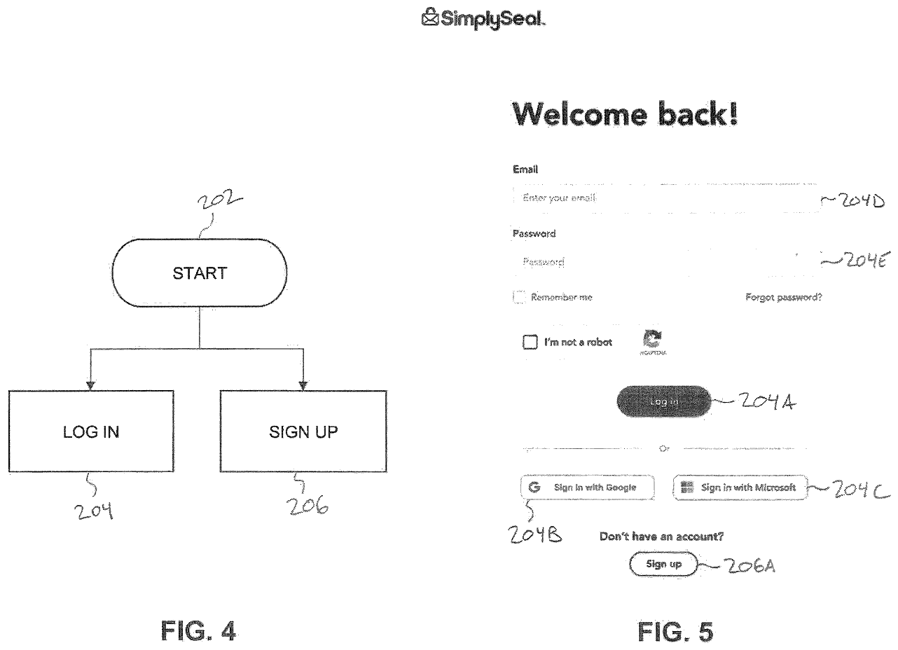

Referring now to FIG. 4, upon accessing system 100, as illustrated by start element 202, a user, such as a property owner, property manager, bidder, or other participant, is presented with the option to either log in 204 or sign up 206 with the system 100. FIG. 5 illustrates an exemplary user interface with elements to log in 204A, 204B, and 204C, or sign up 206A. A user can log in with a local account by entering a user identification—an email address in preferred embodiments—in field 204D and password in field 204E before engaging element 204A. Alternatively, a user can log in using a social account by engaging element 204B or 204C, as appropriate. A new user will engage element 206A to create an account for logging into in the future: Upon engaging element 206A, the user will be presented with an interface to create a new account, either having a user identification and password, or associated with a social account.

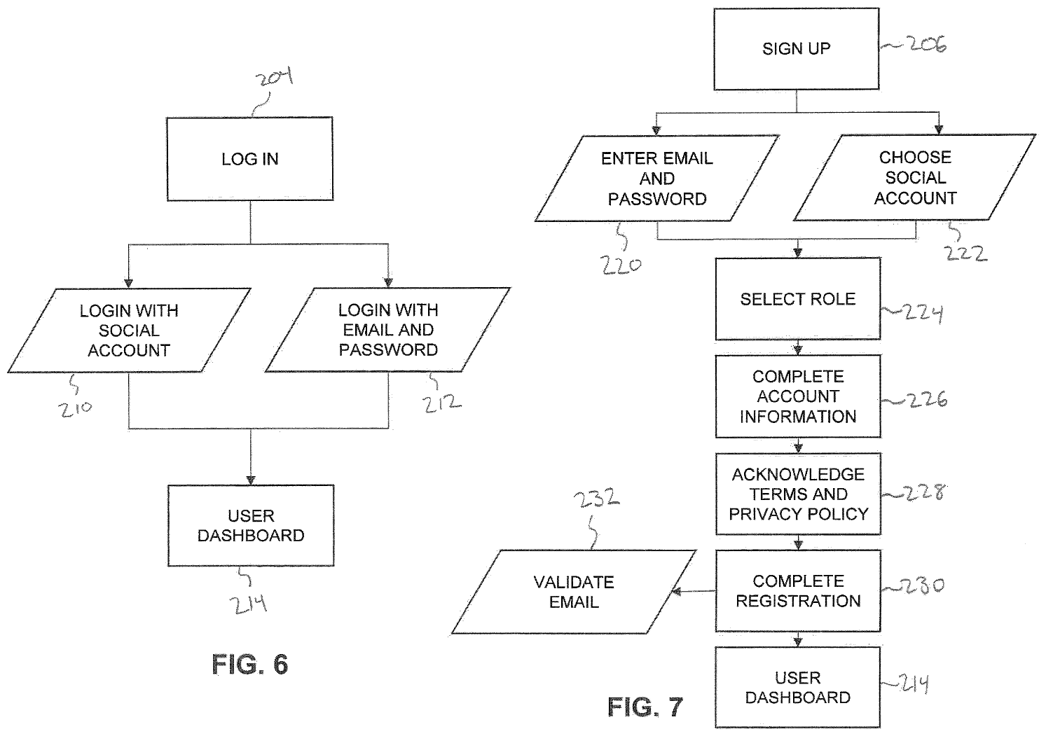

Referring now to FIG. 6, a user can log in 204 using either a social account 210, or an entirely local account 212 with a user identification, such as an email address, and a password. Upon logging in 204, the user is presented with a user dashboard 214.

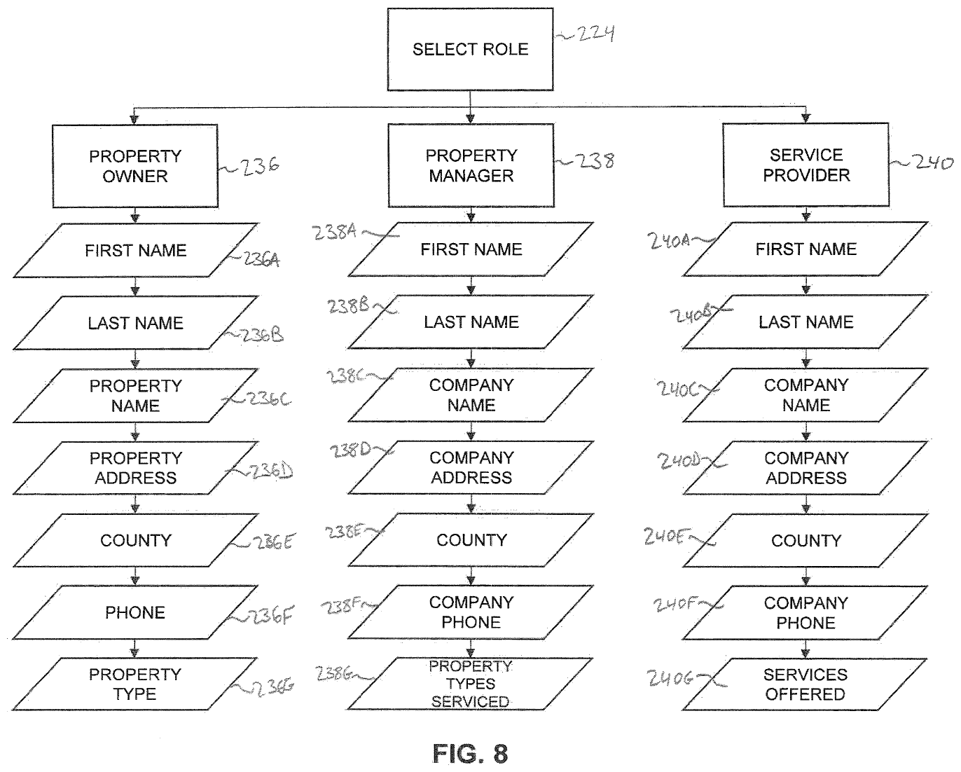

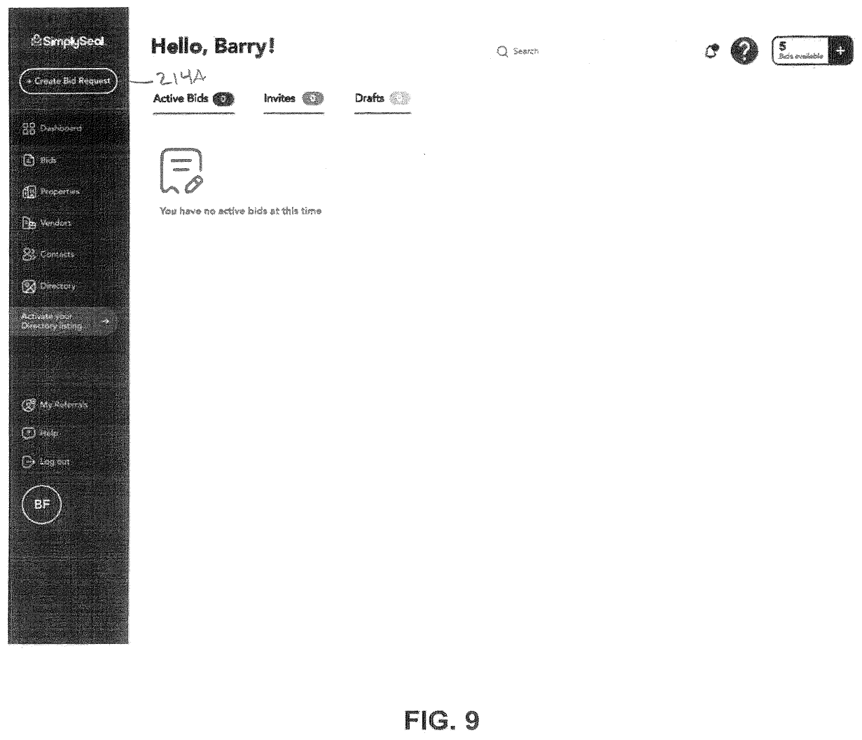

Referring now to FIG. 7, A new user needs to sign up 206 before the user will be able to log in 204. In preferred embodiments, the user can sign up with a local account 220 using an email address (or other identifier in some alternative embodiments) and password, or alternatively with a social account 222. In order to complete the registration process, the user selects a role 224 and enters information 226 as appropriate for the selected role; these steps are further illustrated in FIG. 8. In preferred embodiments, the user then acknowledges the terms of use 228 for system 100 (shown in FIGS. 1-2), thereby completing registration 230. The user is then redirected to the user dashboard 214, but when signing up with a local account 220 in preferred embodiments, must also validate the email address provided 232 within twenty-four (24) hours. The time limit for validation may vary from twenty-four (24) hours in alternate embodiments.

Referring now to FIG. 8, as mentioned previously, a new user selects a role 224 while signing up 206 (shown in FIG. 7). In preferred embodiments, available roles include property owner 236, property manager 238, and service provider (also referred to as “vendor” or “contractor” elsewhere herein) 240.

For a property owner 236, the information collected includes first name 236A, last name 236B, property name 236C, property address 236D, county 236E, phone 236F, and property type 236G.

For a property manager 238, the information collected includes first name 238A, last name 238B, company name 238C, company address 238D, county 238E, company phone 238F, and the property types serviced 238G by the property manager 238.

For a service provider 240, collected includes first name 240A, last name 240B, company name 240C, company address 240D, county 240E, company phone 240F, and the services offered 240G by service provider 240.

Referring now to FIG. 9, an exemplary user interface for dashboard 214 is illustrated. Via dashboard 214, property owners 236 and property managers 238 create bid requests, and service providers 240 receive invitations and create bids. For example, user interface element 214A is engageable to display a user interface for the creation of a bid request.

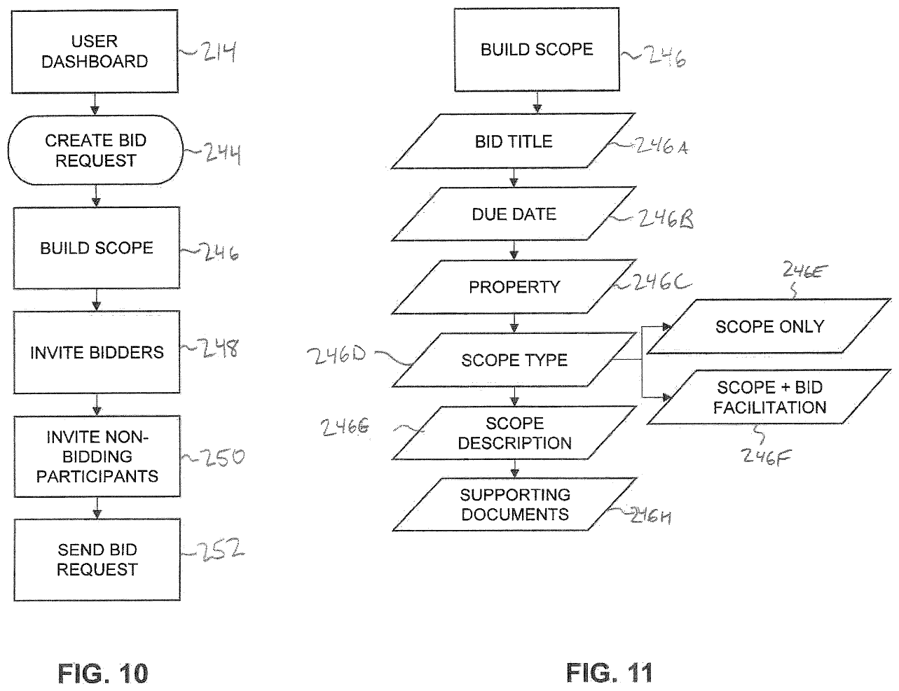

Referring now to FIG. 10, when a property owner 236 or property manager 238 engages an interface element 214A from dashboard 214 to create a bid request 244, the user enters data to build the scope 246 of the bid, invites bidders 248, and invites non-bidding participants 250. The system 100 then sends the bid request 252 to the invited bidders.

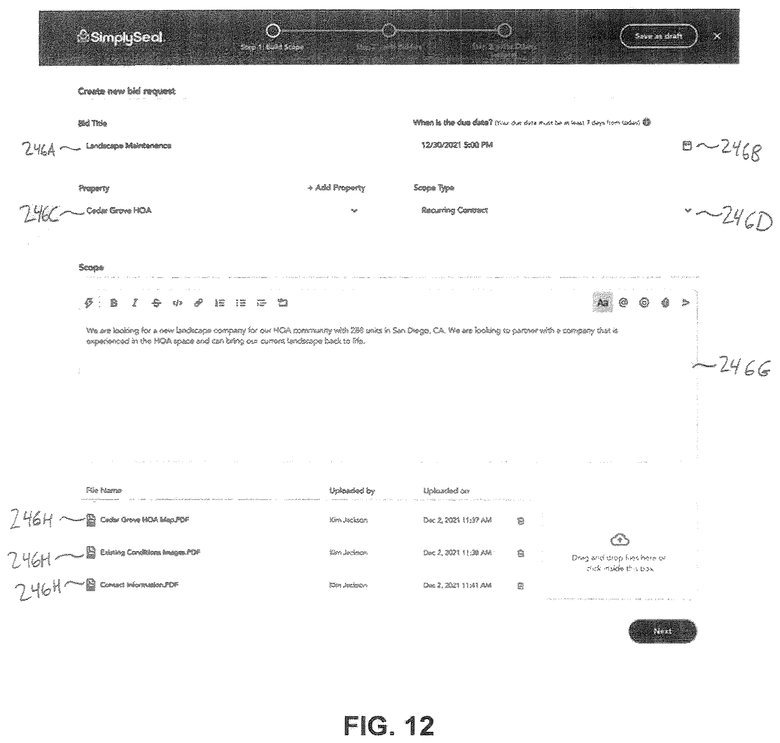

FIG. 11 illustrates exemplary data used to build the scope 246 of a bid in preferred embodiments. FIG. 12 illustrates an exemplary user interface for building the scope 246 of a bid. As shown in FIGS. 11 and 12, preferred embodiments of an interface for creating a bid request 244 include fields for entry of a bid title 246A, a due date 246B, a property 246C, a scope type 246D such as scope only 246E or scope and build facilitation 246F, and a scope description 246G. Additional user interface elements allow for uploading and removal of supporting documents 246H. In preferred embodiments of system 100, due date 246B—the deadline for submitting bids—must be seven (7) or more days after the creation of the bid request, in order to allow for a scope question-and-answer (Q/A) period that ends at least forty-eight (48) hours prior to the due date 246B.

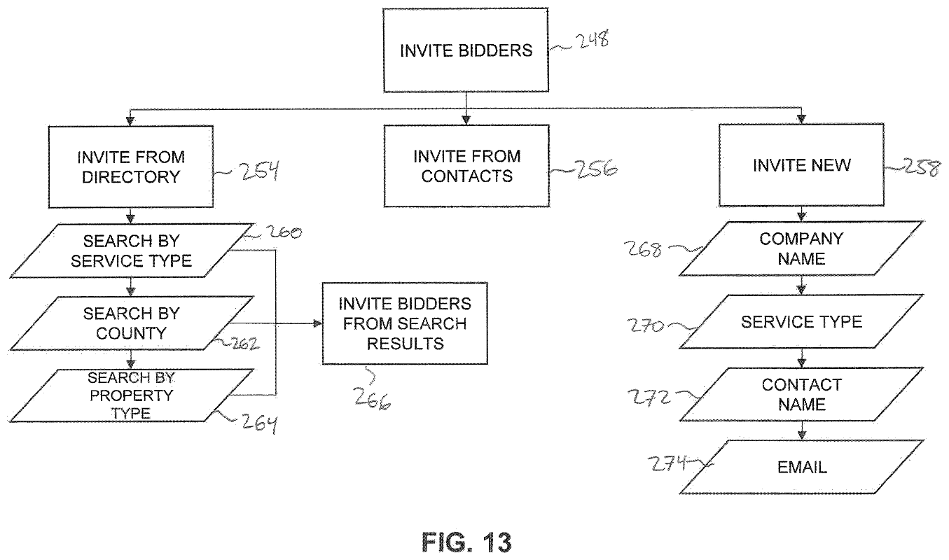

Referring now to FIG. 13, once the bid scope is defined, the user invites bidders 248. Bidders can be invited from a directory 254 provided by system 100 (shown in FIGS. 1 and 2), from the user's contacts 256, or from data entered directly by the user 258. When inviting from a directory 254, the user can search by the types of services 260 offered by a vendor, by county 262, and by the types of property serviced 264. The user then invites bidders from the search results 266. When directly inviting 258 a bidder, the user provides the company name 268, types of services 270 offered by the vendor, a contact name 272, and an email address 274 through which the potential bidder will be contacted.

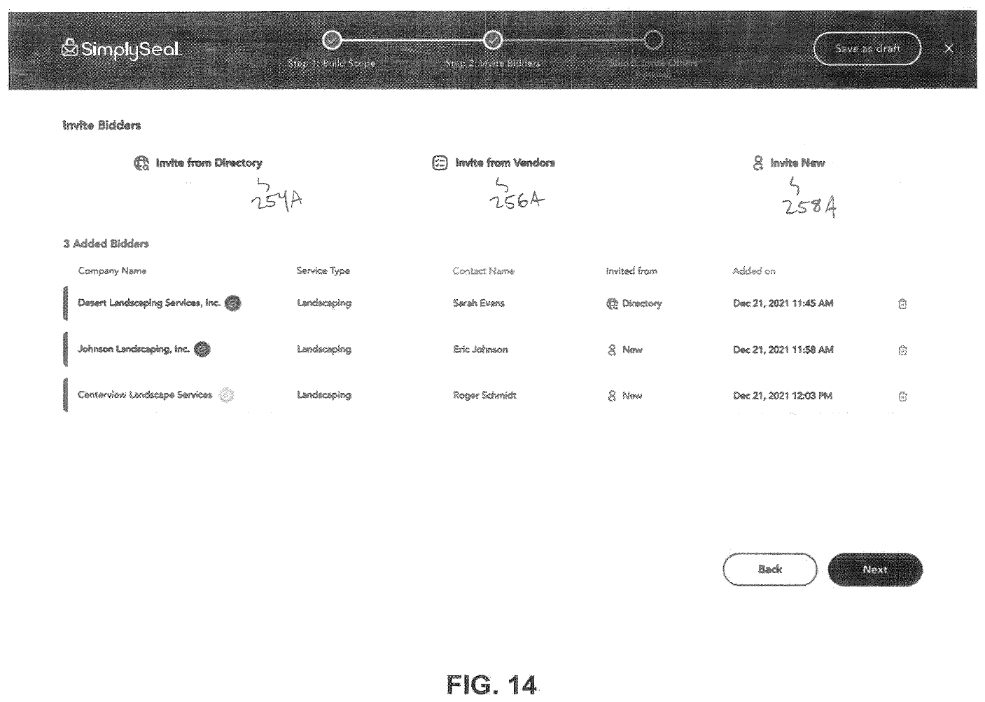

FIG. 14 illustrates an exemplary user interface for inviting bidders as used in a preferred embodiment of system 100. The user interface includes elements 254A, 256A, and 258A that are engageable by the user to invite bidders from the directory 254, from contacts 256, or directly 258, respectively.

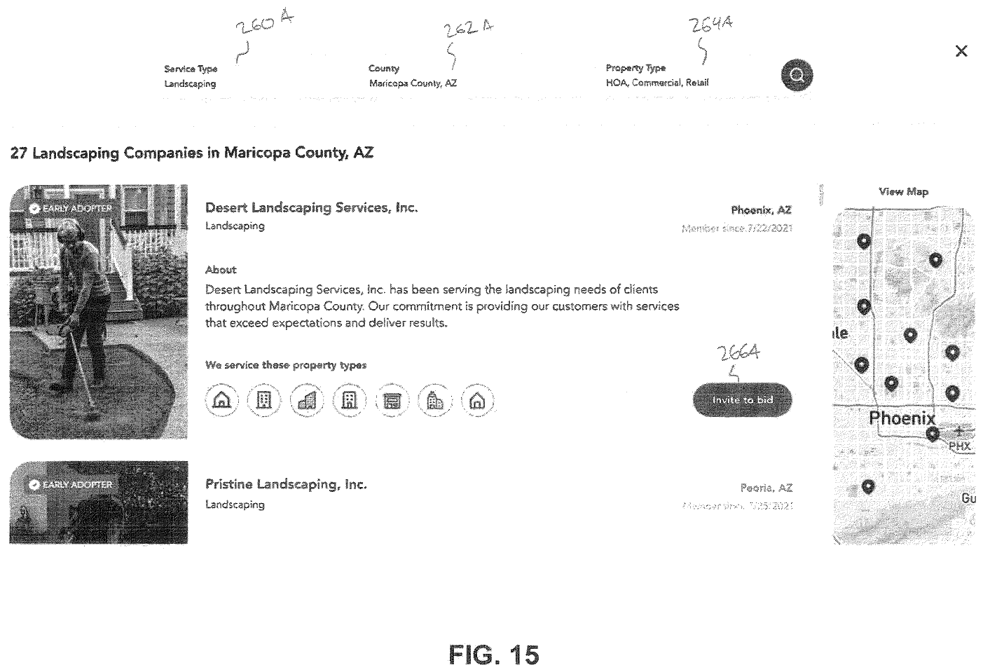

Referring now to FIG. 15, an exemplary user interface for inviting bidders from a directory 254 is illustrated. As illustrated, a user has used interface element 260A to search by types of services 260, interface element 262A to search by county 262, and interface element 264A to search by types of property serviced 264. By including all three parameters in the search, the user receives results tailored to the user's specific needs. The user can send bid invitations to vendors from the search results 266 through a user interface element 266A that appears on each search result in preferred embodiments.

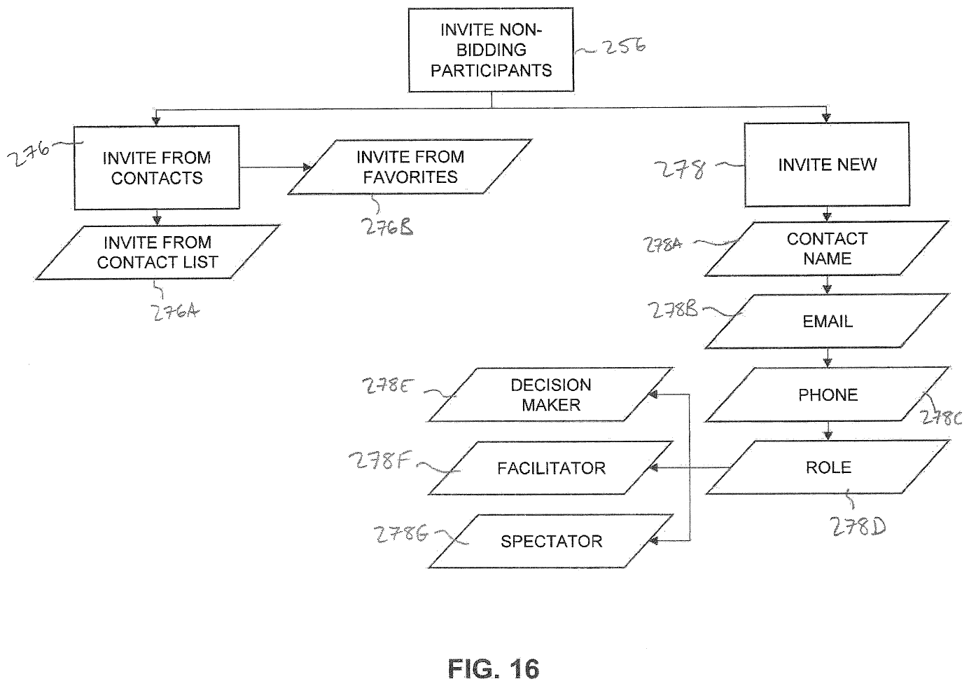

Referring now to FIG. 16, when the user invites non-bidding participants 256, the non-bidding participants can be invited from the user's contacts 276 or invited from data input directly 278 by the user. Preferred embodiments of system 100 provide two methods of inviting from contacts 276, including inviting non-bidding participants from a contact list 276A, and inviting non-bidding participants from a favorites list 276B. When inviting a new non-bidding participant 278, the user enters a contact name 278A, email address 278B, phone number 278C, and the non-bidding participant's role 278D. In preferred embodiments, role 278D is decision maker 278E, facilitator 278F, or spectator 278G.

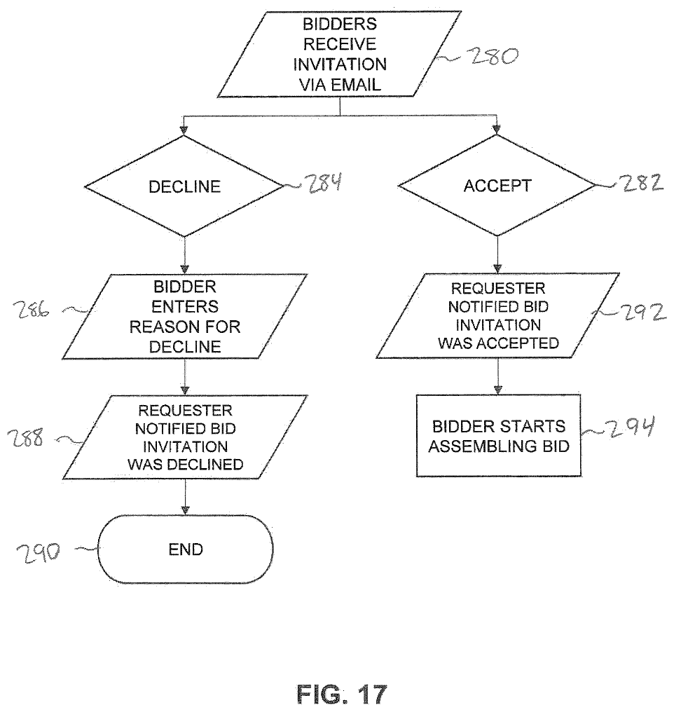

Referring now to FIG. 17, when the bid is assembled and the user has selected the participants to invite, bidders receive an email invitation 280 to submit a bid. They can either accept 282 or decline 284 the invitation. When declining 284, system 100 invites bidders to enter a reason for declining 286. The requester—the property owner 236 or property manager 238 (see FIG. 8) who created the bid request—is notified that the bid invitation was declined 288. The illustrated process then ends as far as the declining bidder is concerned, as illustrated by end element 290.

If the bidder accepts the invitation 282, the requester is notified that the bid invitation was accepted 292, and the system 100 allows the bidder to start assembling a bid 294.

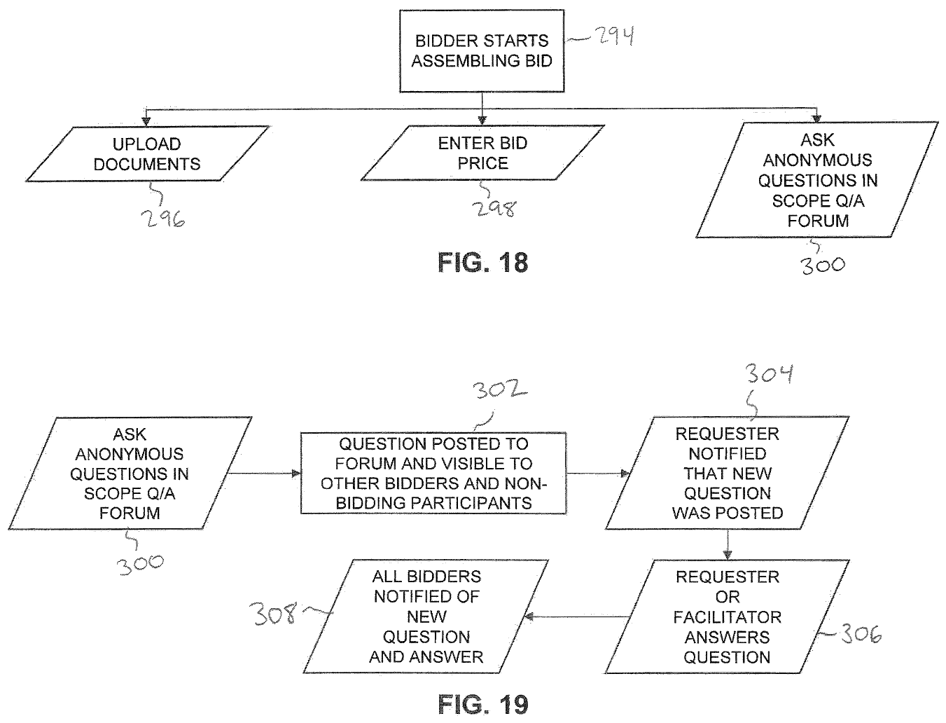

Referring now to FIG. 18, the bidder starts assembling a bid 294 by uploading documents 296 related to the bid, such as a proposal, entering the bid price 298, and asking questions, if the bidder has any, anonymously in the scope question-and-answer (Q/A) forum 300.

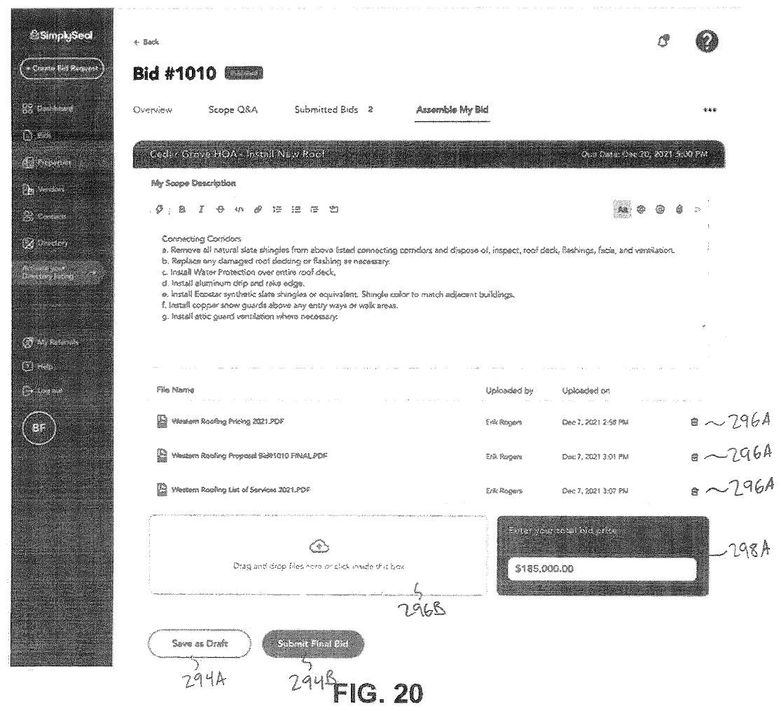

As illustrated in FIG. 19, when a bidder asks a question in the scope Q/A forum 300, the question is posted to the forum 302 and is visible to all participants. However, in preferred embodiments of system 100, the name of the bidder who asked is not displayed in order to provide anonymity for bidders with questions. The bid facilitator is then notified 304 that a new question was posted, and the bid facilitator answers the question 306. All bidders are notified of a new question and answer 308, which are made visible to bidders and other participants.

Referring now to FIG. 20, an exemplary user interface for assembling a bid is illustrated. The bidder can upload documents 296A using user interface element 296B. A bid price is entered using user interface element 298A. The bid can be saved with user interface element 294A. As described previously, the bid cannot be finalized until the scope Q/A period ends. When the scope Q/A period ends, user interface element 294B can be engaged to submit the final bid; until that point, it is disabled.

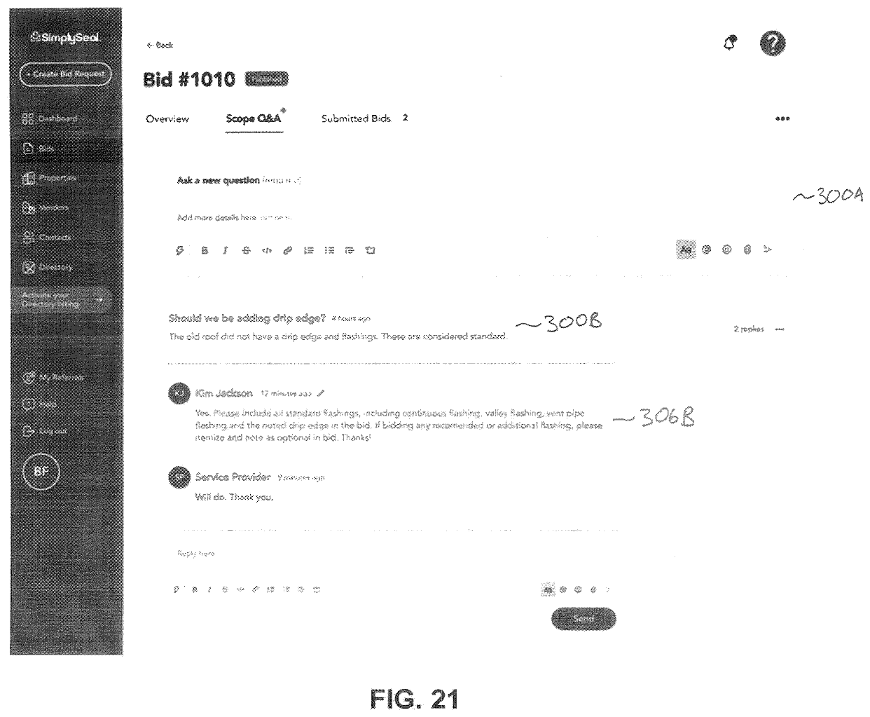

Referring now to FIG. 21, an exemplary user interface for the scope Q/A forum, as seen by a bidder, is illustrated. The bidder asks a question using user interface element 300A. As illustrated, in a preferred embodiment user interface element 300A includes a field for the question, and a field for additional details about the question. The question appears to all participants including bidders and non-bidding participants, as illustrated by text 300B. The bid facilitator's answer, once provided, also appears to all participants, as illustrated by text 306B. In some preferred embodiments, the bidder can follow up with remarks or additional questions based on the requester's answer.

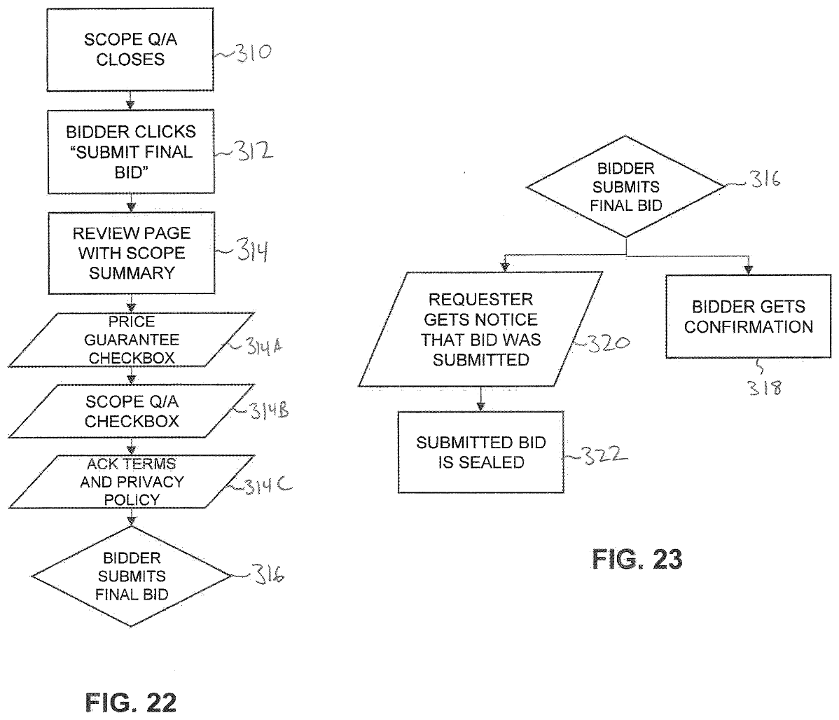

Referring now to FIG. 22, the scope Q/A period closes 310 forty-eight (48) hours prior to the bid deadline in preferred embodiments of system 100. Once the scope Q/A period closes 310, user interface 294B (see FIG. 20) becomes engageable by bidders to finalize their bids. When a bidder engages user interface element 294B, as illustrated by flowchart element 312, the user is presented with a review page with a summary of the bid scope 314. The review page 314 includes a price guarantee checkbox 314A, a scope Q/A checkbox 314B, and a checkbox 314C to acknowledge the terms of use and privacy policy for use of system 100. In preferred embodiments, checkbox 314C must be selected in order to submit the final bid 316, but checkboxes 314A and 314B are optional. By selecting checkbox 314A, the bidder promises to the requester that the bid includes everything in the scope of work and scope Q/A, and that change orders will not be submitted unless the scope of work is changed. By selecting checkbox 314B, the bidder indicates that the bid includes the information discussed in the scope Q/A; if checkbox 314B is selected, the contents of the scope Q/A are attached in PDF format to the bidder's documents.

Referring now to FIG. 23, when the bidder submits the final bid 316, the bidder receives confirmation 318 of the successful bid, and the bid facilitator is notified that the bid was submitted 320. However, the submitted bid is sealed 322, so that the bid facilitator and others are unable to view the bid's details until all bids are submitted.

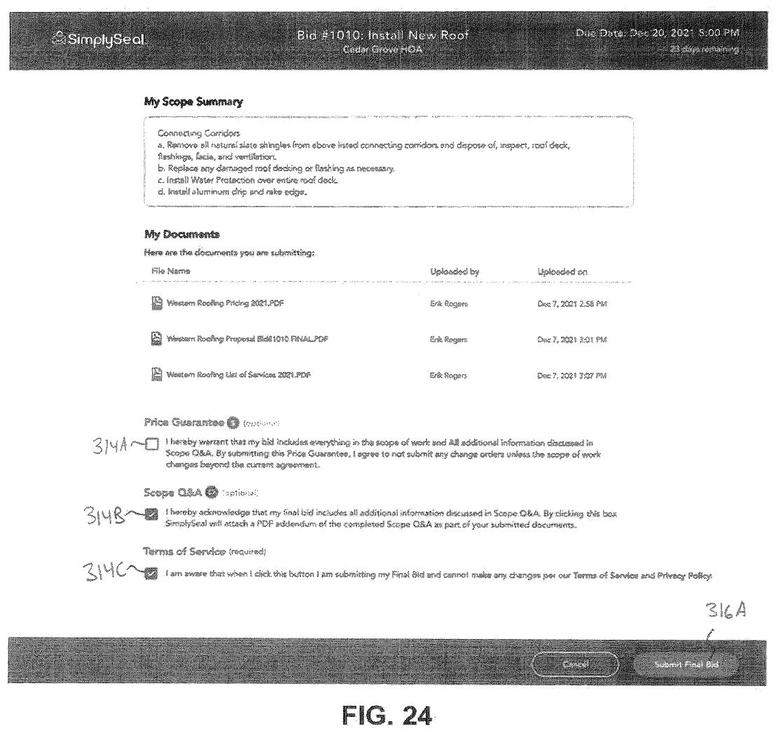

Referring now to FIG. 24, an exemplary user interface of the review page with a summary of the bid scope 314 is illustrated. The bidder's scope summary is shown along with documents submitted by the bidder. Checkbox 314A allows the bidder to include a price guarantee, and checkbox 314B allows the bidder to include the scope Q/A discussion as part of the bid. Checkboxes 314A and 314B are optional, but improve the quality of the bid and therefore may improve the bidder's chances of success. Checkbox 314C acknowledges terms of use and the privacy policy, and must be checked before a final bid can be submitted. The bidder submits the final bid 316 by engaging user interface element 316A.

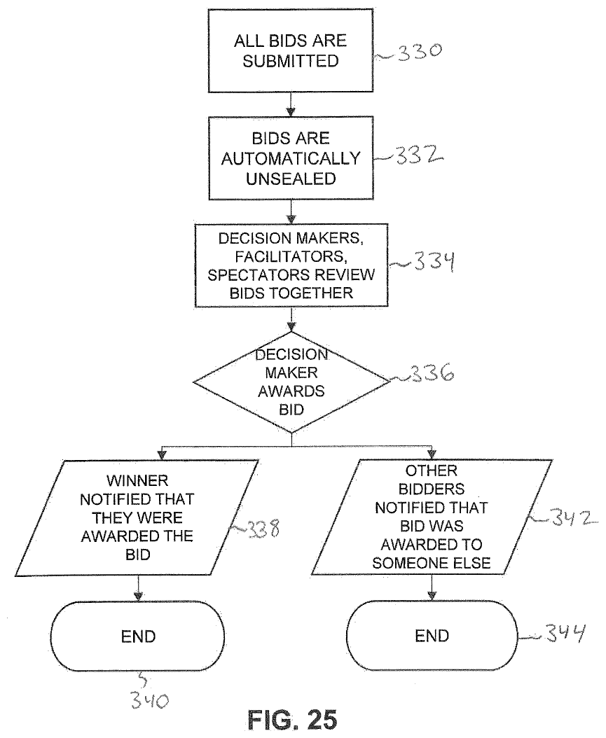

Referring now to FIG. 25, after all bids are submitted 330 or the bid deadline passes, the system 100 automatically unseals all bids 332. Decision makers, work purchasers, bid facilitators, and spectators then review all bids together 334. The decision maker, whether that is the work purchaser or bid facilitator, then awards the bid 336. The winning bidder is notified 338 that they were awarded the bid, marking the end of the process as far as they are concerned, as illustrated by end element 340. The other bidders are notified 342 that the bid was awarded to someone else, marking the end of the process for them also, as illustrated by end element 344.

The invention described herein is applicable across a spectrum of industries. The preferred embodiments detailed above are merely exemplary of the application of the present invention to the property and property maintenance industries, and outline the exchange of information from those seeking bids, those seeking to present bids, and those decision makers selecting the best bid for the project. The selection of these preferred embodiment is not intended to create a limitation as to the applicability of the present invention to a particular industry.

Thus, while there have been shown what are presently considered to be preferred embodiments of the present invention, it will be apparent to those skilled in the art that various changes and modifications can be made herein without departing from the scope and spirit of the invention.

What is claimed is:

1. A system for contract bidding, comprising:
a processor; and
a data storage medium containing instructions configured to be operated on by the processor, wherein the instructions cause the processor to:
receive bid request input data from a bid facilitator,
create a bid request from the input data,
invite participants, the participants comprising bidders,
send a bid request to each bidder,
receive questions from participants,
receive answers to the questions from the bid facilitator,
display the questions and the answers to participants,
receive bids from the bidders,
seal the bids received from the bidders as they are received,
unseal the bids when all bids are received,
receive a decision from a decision maker, the decision comprising an accepted bid,
notifying a bidder who submitted the accepted bid that the bidder won, and
notifying the other bidders that they did not win.

2. The system for contract bidding of claim 1, wherein the participants further comprise non-bidding participants.
